(19) United States
(12) Patent Application Publication
(10) Pub. No.: US 2004/0094190 A1
(43) Pub. Date: May 20, 2004

(54) Water displacement/vortex inhibiting device

(75) Inventor: Maxime Robert, L'Ancienne Lorette (CA)

Correspondence Address: Mark Kusner, Highland Place, Suite 310, 6151 Wilson Mills Road, Highland Heights, OH, 44143, US

(73) Assignee: STERIS Inc.

(21) Appl. No.: 10/295,256

(22) Filed: Nov. 15, 2002

(51) Int. Cl. B08B 3/00

(52) U.S. Cl. 134/108; 134/113; 134/186; 134/198

(57) ABSTRACT

A washer including a plurality of spray jets and nozzles is disposed within a washing chamber for spraying washing and rinsing fluids into the washing chamber. Conduits supply the washing and rinsing fluids to the jets. A sump at the bottom of the washing chamber collects the washing and rinsing fluids sprayed from the jets. A pump re-circulates the washing and rinsing fluids from the sump to the conduits and nozzles. The washer is further comprised of a fluid displacement device centrally disposed within the sump. A fluid displacement device is dimensioned to displace fluid within the sump and to define a generally annular sump chamber surrounding the fluid displacement device that communicates with the pump.

### FIELD OF THE INVENTION

The present invention relates generally to the cleaning and decontaminating arts, and more particularly to washers for washing instruments and equipment, such as surgical, medical, dental, veterinary and mortuary instruments and equipment, that contain, or potentially contain biological contaminants. The present invention is particularly applicable to washers for washing the aforementioned instruments and equipment, and will be described with particular reference thereto, although it is to be appreciated that the invention may find application in washers for other types of objects.

### BACKGROUND OF THE INVENTION

Known washers for washing instruments and equipment exposed to biological contaminants typically include a preliminary rinse cycle, a pre-wash cycle, a wash cycle and a final rinse cycle. During each cycle, a rinse fluid or a cleaning fluid is re-circulated through the washer by a pump that forces the fluid to spray jets in a washing chamber. After each cycle, the washer is drained and refilled with clean fluid.

Depending upon the number of sprayers on a basket or rack within the washer, it is known to operate such washers at different fluid pump speeds. In this respect, depending upon the instruments or equipment to be washed, it is known to use different types of racks or baskets within the washer These racks or baskets may have different numbers of spray nozzles attached thereto. The washer also has controls that would allow different fluid pump speeds based upon the number of spray nozzles on the basket or cart. It is not unusual for a pump to be operable to produce a fluid flow rate in excess of 200 gallons per minute at high operating speeds.

Most washers include some type of sump arrangement at the bottom of the washing chamber to collect fluid sprayed into the washing chamber. This fluid is recycled through the pump and back to the spray nozzles. Prior to operation of the pump during a washing or rinsing cycle, the sump is typically filled to a certain level with a washing fluid or a rinse fluid to establish a certain pressure at the pump. In other words, a certain height of fluid is required to prime the pump prior to the operation thereof. Heating elements are also typically provided within the sump to heat the cleaning or washing fluids.

Heretofore, sumps in washers were designed to hold the requisite amounts of fluid to prime and operate the pump at its highest operating speed and to prevent cavitation of the pump, i.e., air being drawn into the pump. Such cavitation is the result of air being drawn into the pump from the sump. In this respect, high pump speeds cause the fluid in the sump to swirl into a whirlpool producing an inner vortex of air that might reach the pump during operation if sufficient fluid does not exist in the sump. To create sufficient head pressure to prime the pump and to prevent cavitation, prior sump designs required significantly more fluids than were actually required to operate the pump even at its highest operating speed.

The present invention overcomes the aforementioned and other problems, and provides a new and improved sump design that requires less operating fluid for pump operation and that reduces the likelihood of cavitation in the pump.

### SUMMARY OF THE INVENTION

In accordance with a preferred embodiment of the present invention, there is provided a washer that includes a plurality of spray jets disposed within a washing chamber for spraying washing and rinsing liquids into the washing chamber. Conduits supply the washing and rinsing liquids to the jets. A sump at the bottom of the washing chamber collects the washing and rinsing liquids sprayed from the jets. A pump re-circulates the washing and rinsing liquids from the reservoir to the conduits and nozzles. The washer is further comprised of a fluid displacement device centrally disposed within the sump. A fluid displacement device is dimensioned to displace fluid within the chamber and to define a generally annular sump chamber surrounding the fluid displacement device that communicates with the pump.

In accordance with another embodiment of the present invention, there is provided a reservoir for a washer that includes a washing chamber, a plurality of spray jets disposed within the washing chamber, conduits for supplying washing and rinsing liquids to the spray jets, and a pump connected to the conduits for re-circulating the washing and rinsing fluids within the washer to the spray jets. The reservoir is disposed at the bottom of the washing chamber and is comprised of a cavity having a fixed fluid capacity. A hollow body is centrally disposed within the cavity to displace a fixed volume of the fluid capacity. The hollow body defines an annular reservoir cavity that communicates with the pump.

An advantage of the present invention is a washer as described above for washing instruments and equipment, such as surgical, medical, dental, veterinary and mortuary instruments and equipment, which contain or potentially contain biological contaminants, that utilizes less washing or rinsing fluids during a washing or rinsing cycle.

Another advantage of the present invention is a washer as described above that utilizes less chemicals per washing cycle.

Another advantage of the present invention is a washer as described above that more efficiently heats washing and rinsing fluids.

A still further advantage of the present invention is a washer as described above, wherein pump cavitation is less likely.

A still further advantage of the present invention is a washer as described above having shorter fill cycle times because of the use of less washing and rinsing fluids.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a partially sectioned, elevational view of the lower portion of a washer, illustrating a fluid reservoir according to a preferred embodiment of the present invention;

FIG. 2 is a sectional view taken along lines 2-2 of FIG. 1;

FIG. 3 is a sectional view taken along 3-3 of FIG. 2;

FIG. 4 is a pictorial illustration of two like sumps, illustrating the different levels and volumes of fluid necessary to “prime” a pump for operation at two different pump operating speeds;

FIG. 5 is a pictorial illustration of a conventional sump and a sump containing a fluid displacement device according to the present invention, illustrating how the “head pressure” necessary to prime a pump for high pump operating speeds may be established utilizing the same amount of fluid conventionally used to prime a pump for a low operating speed; and

FIG. 6 is an elevational view of a conventional sump design.

### DETAILED DESCRIPTION OF A PREFERRED EMBODIMENT

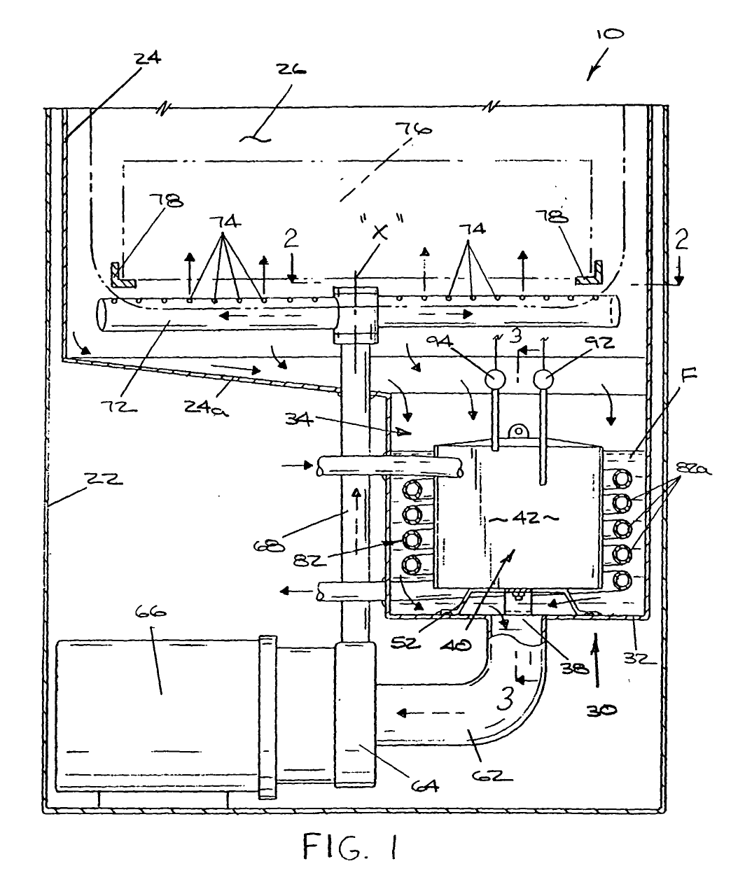

Referring now to the drawings wherein the showings are for the purpose of illustrating a preferred embodiment of the invention only, and not for the purpose of limiting same, FIG. 1 is a partially-sectioned view of the lower portion of a washer 10 for washing instruments and equipment, such as surgical, medical, dental, veterinary and mortuary instruments and equipment. Washer 10 is similar to washers disclosed in prior U.S. Pat. No. 5,749,385 to Rochette et al. entitled: METHOD AND APPARATUS FOR LOOSELY RETAINING INSTRUMENTS IN A WASHING SYSTEM RACK ASSEMBLY and U.S. Pat. No. 5,759,289 to Caron et al. entitled: CENTRAL HEADER FOR LIQUID CLEANING UNITS, the disclosures of which are expressly incorporated herein by reference.

Washer 10 includes an outer housing 22 and an inner shell 24 that defines a washing chamber 26. Shell 24 has a bottom wall 24a that is formed to slope toward a sump assembly 30 that is disposed at the bottom of washing chamber 26. As will be described in greater detail below, sump assembly 30 is provided to receive washing fluids or rinsing fluids “F” used in washing chamber 26. A drain 38 is formed in the bottom of sump assembly 30. A first conduit 62 connects drain 38 of sump assembly 30 to an inlet of a fluid pump 64 that is driven by a motor 66. A second conduit 68 connects the outlet of fluid pump 64 to washing chamber 26. In the embodiment shown, second conduit 68 is connected to a spray arm 72. Spray arm 72 is rotatable about an axis designated “X” in the drawings. Spray arm 72 is basically an elongated tubular member that is sealed at its distal ends and that includes a plurality of spaced-apart openings or apertures 74 along its upper surface. Apertures 74 are dimensioned to create spray nozzles or spray jets that direct fluid upwardly into washing chamber 26. In the embodiment shown, spray arm 72 is disposed near the bottom of washing chamber 26 below a basket or rack 76 (shown in phantom in FIG. 1) that is adapted to contain instruments or equipment (not shown) to be washed. Basket or rack 76 is supported on guides 78. As will be appreciated by those skilled in the art, washing chamber 26 may contain an upper spray arm (not shown) as illustrated in the aforementioned U.S. Pat. No. 5,749,385 to Rochette et al. In addition, washing chamber 26 may be adapted to have a header and spray arrangement, as illustrated in U.S. Pat. No. 5,759,289 to Caron et al. As is also known to those skilled in the art, washers of the type heretofore described may include baskets or racks having spray ports that may be plugged or unplugged to facilitate washing of different types of instruments or equipment in the same washer.

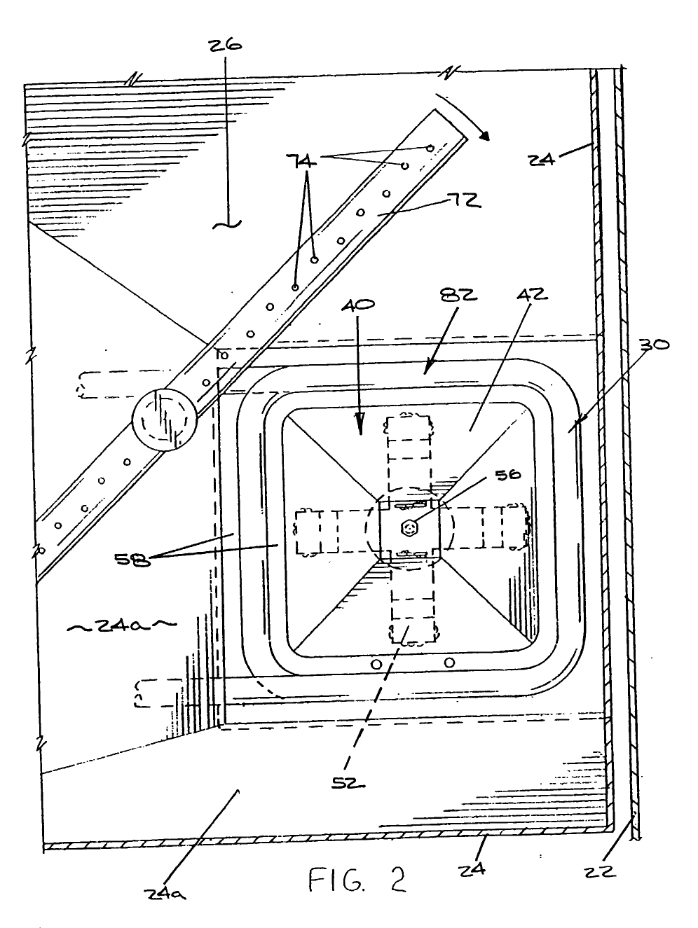

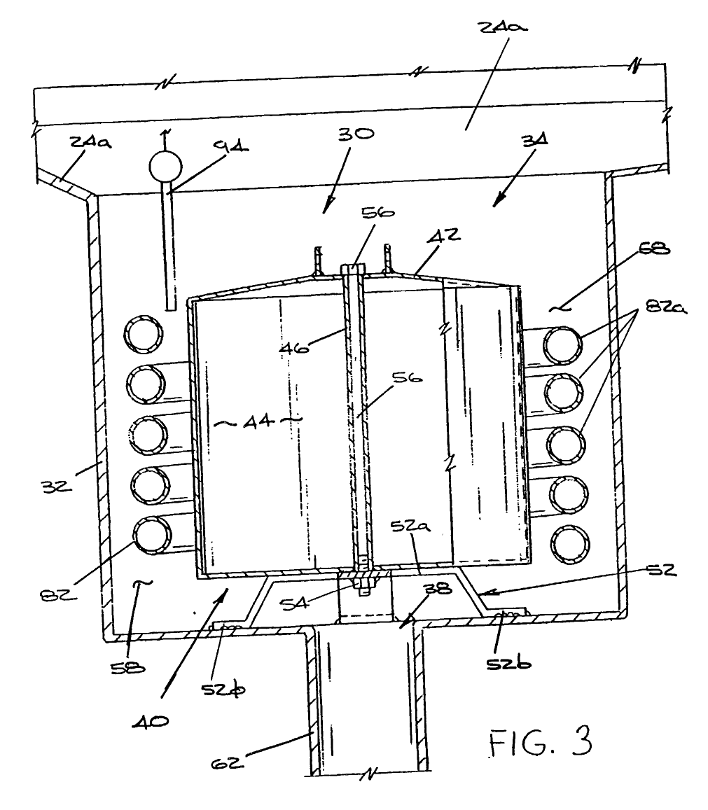

Referring now to FIGS. 2 and 3, sump assembly 30 is best shown. Sump assembly 30 is comprised of a vessel 32 disposed at the bottom of washing chamber 26. Vessel 32 has an open upper end that communicates with washing chamber 26. Vessel 32 defines a cavity 34. In the embodiment shown, vessel 32 is rectangular in shape and is integrally formed as part of inner shell 24. It is to be appreciated however, that vessel 32 may be a separate element that is attached to inner shell 24, and that vessel 32 may assume shapes other than rectangular, such as, by way of example and not limitation, cylindrical, oval or conical. An opening in the bottom of vessel 32 defines drain 38. A fluid displacement device 40 is centrally disposed within cavity 34 of vessel 32. Fluid displacement device 40 is disposed above and spaced from drain 38, as best seen in FIG. 3. Fluid displacement device 40 is preferably shaped to have a cross-section matching the cross-section of vessel 32. In the embodiment shown, fluid displacement device 40 is rectangular in shape, and is comprised of a sealed canister 42 having a hollow interior cavity 44. A tube or pipe 46 extends through cavity 44 of canister 42 to the upper and lower ends thereof. Tube 46 and canister 42 are preferably formed of a non-corrosive, non-rusting metal, such as, by way of example and not limitation, stainless steel. Tube 46 is welded or soldered to canister 42 to form a fluid-tight joint therebetween.

Fluid displacement device 40 is positioned above drain 38 on a bracket 52. Bracket 52 is generally cross-shaped (as best seen in phantom in FIG. 2). Bracket 52 has a support section 52a offset for mounting to pad 52b. Mounting pads 52b are welded to the bottom of bracket 52. Bracket 52 includes a central opening (not shown), and a conventional, threaded nut 54 is welded to the bottom of bracket 52 in registry with the opening in bracket 52. An elongated bolt 56 extends through the opening of tube 46 and is threaded into nut 54 to secure canister 42 to bracket 52. O-rings or gaskets (not shown) may be provided at the ends of bolt 56, i.e., between bolt 56 and canister 42, to provide an additional sealing of canister 42. As best seen in FIG. 3, fluid displacement device 40 is preferably disposed directly above drain 38 and the center of cavity 34 defined by vessel 32.

An annular sump chamber 58 is defined between vessel 32 and fluid displacement device 40. As best seen in FIG. 2, sump chamber 58 is annular in the sense that it surrounds fluid dispensing device 40, and is generally ring-shaped. Sump chamber 58 is symmetrical about an axis through fluid displacement device 40 and drain 38.

A heating element 82 is disposed within sump chamber 58. In the embodiment shown, heating element 82 is in the shape of a rectangular coil having a plurality of loops 82a that surround fluid displacement device 40. Heating element 82 is essentially an elongated tube dimensioned to convey steam from a steam generating device (not shown) therethrough. It is to be appreciated that heating element 82 may also be an electrical heating element.

Fluid sensors 92, 94, schematically illustrated in the drawings, are provided in sump chamber 58 to provide an indication of the level of fluid therein. Fluid level sensor 92 represents a low fluid level sensor and fluid sensor 94 represents a high fluid level sensor. In the embodiment shown, fluid sensors 92, 94 are float devices operable to float as the level of fluid in sump chamber 58 rises. Both sensors are operable to provide signals when the respective fluid sensor has reached a predetermined level. Namely, sensors 92, 94 are operable to provide signals to the washer's controller system (not shown).

Referring now to the operation of washer 10, sump chamber 58 is filled to a predetermined level with a fluid, such as a washing fluid or a rinsing fluid, at the beginning of a washer cycle, i.e., at the beginning of a rinse cycle, a pre-wash cycle or a wash cycle. Such fluids are generally comprised of water or water mixed with detergents, wetting agents, soaps, disinfectants and the like. The level of fluid to be added to sump chamber 58 is based upon the operating speed of pump 64. In this respect, a certain level of fluid is needed in sump chamber 58 to create sufficient pressure, conventionally referred to as “head pressure,” to prime pump 64. The level of fluid required in sump chamber 58 is based upon the operating speed of pump 64. As indicated above, the speed of pump 64 is generally related to the number and configuration of spray nozzles or spray jets used in washer 10. Washer 10 may be adaptable to use different numbers and arrangements of spray nozzles or spray jets and therefore, typically has more than one pump operating speed. In this respect, conventional washers typically have pumps that operate at two speeds, namely a high speed, wherein pump 64 has an output of 200 gallons/minute or more, and a lower speed, wherein the pump has an output of approximately 80 to 100 gallons/minute.

Prior to activation of pump 64, sump chamber 58 is filled with a washing or rinsing fluid designated “F” in FIG. 1 by conventional means. Sump chamber 58 is allowed to fill until fluid F has reached a predetermined level as determined by sensor 94 (for a high pump operating speed) or by fluid sensor 92 (for a lower pump operating speed). At the predetermined level, sufficient head pressure is established at the inlet to pump 64 to prime pump 64. Activation of pump 64 causes fluid F to be pumped to spray arm 72 and to apertures 74. Fluid F is sprayed into washing chamber 26 onto instruments or equipment in basket 76 as spray arm 72 rotates about axis X. As indicated above and as shown in U.S. Pat. Nos. 5,749,385 and 5,759,289, pump 64 may direct fluid F to different types of washing rack arrangements. Fluid F sprayed from apertures 74 of spray arm 72 eventually settles to the bottom of washing chamber 26 where it is collected within sump chamber 58 of sump assembly 30. From sump chamber 58, fluid F is sucked into pump 64 to be re-circulated back into washing chamber 26. The flow of fluid F is depicted by arrows in FIG. 1. As fluid F is re-circulated through sump chamber 58, fluid F flows over and past the plurality of loops 82a of heating element 82, wherein fluid F is heated. In this respect, fluid F is forced to flow through narrow channels defined by the regions located between chamber 58 and the periphery of fluid displacement device 40, and is therefore exposed to the plurality of coils or loops 82a of heating element 82, as it flows therethrough. The generally helical configuration of heating element 82, and the relatively large size of coils or loops 82a relative to the size of sump chamber 58, facilitates efficient heating of fluid F as it passes through sump chamber 58.

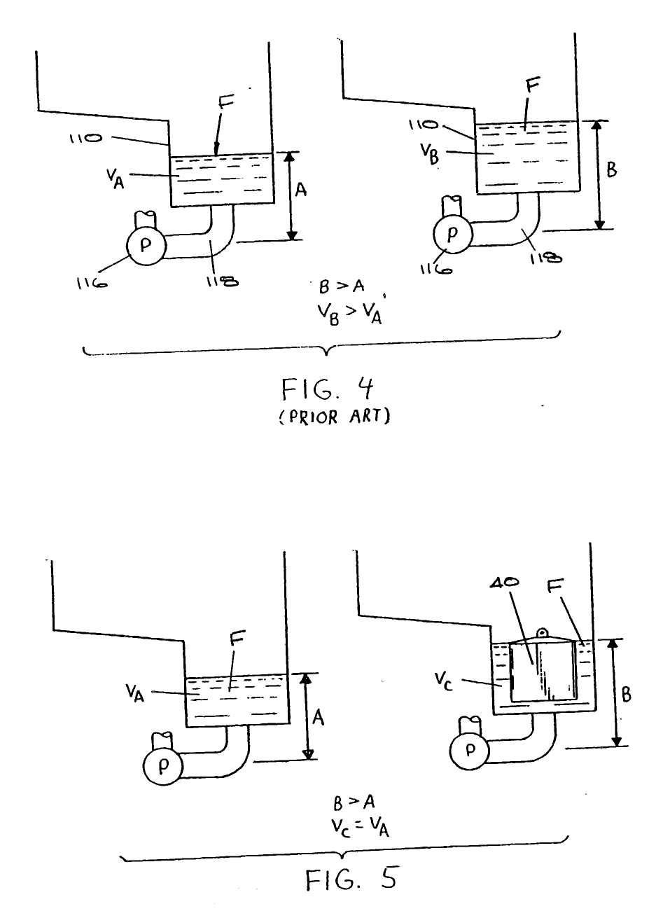

The advantages of washer 10 and sump assembly 30 shall now be described with reference to FIGS. 4-6. FIG. 6 shows a conventional sump design 110 for a washer, wherein a heating element 112 is arranged in a horizontal plane within sump 110. Sump 110 has a drain 114 that communicates with a pump 116 via a conduit 118. FIG. 6 illustrates a problem with conventional, deep sump designs. Namely, pump 116, when operating at high speeds, produces a whirlpool effect within sump 110. The swirling motion of fluid F creates a central vortex 120 of air. This vortex 120 of air, at times, may be drawn into pump 116 causing detrimental cavitation thereof. Moreover, as will be appreciated, the heat transfer efficiency of heating element 112 is reduced when portions 120a of heating element 112 are within air vortex 120 and are not in contact with fluid F.

In the present invention, fluid displacement device 40 and bracket 52 of sump assembly 30 reduce the likelihood of cavitation and air entrainment into pump 64. In this respect, fluid displacement device 40 occupies the central region of vessel 32 where a vortex would naturally form. The presence of heating element 82 and bracket 52 in the path or flow of fluid F obstructs the formation of the smooth laminar flow that facilitates formation of a whirlpool and prevents the formation of the air vortex that could potentially be drawn into pump 64.

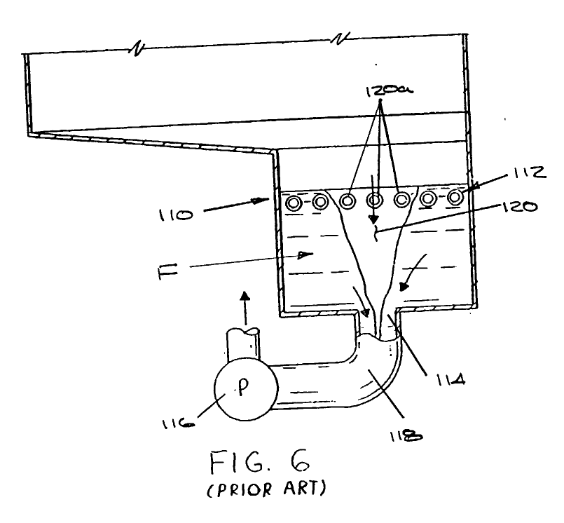

Another advantage of washer 10 and sump assembly 30 is illustrated in FIGS. 4 and 5. FIG. 4 shows two identical sumps 110. One sump 110 is filled with fluid F to a level A for a first pump operating speed, and the other sump 110 is filled to a level B for a higher pump operating speed. As will be appreciated, the volume V_{b} of fluid F that is necessary to fill to level B is greater than the volume Vₐ of fluid F that is necessary to fill to level A. It has been found that volume V_{b} far exceeds the amount of fluid F necessary to operate pump 116 at high operating speeds. In this respect, FIG. 5 illustrates that the addition of fluid displacement device 40 into sump 110 reduces the volume V_{c} of fluid F necessary to establish level B. In this respect, level B can be established with a volume V_{c} of fluid F that is the same as volume Vₐ that is needed to fill a like sump 110 (without fluid displacement device 40) to level A. Thus, insertion of fluid displacement device 40 into sump 110 can provide the necessary head pressure required to prime a pump with a lesser amount of fluid than the same sump without fluid displacement device 40.

Sump assembly 30 is based upon a principle of fluids. The head pressure of a contained fluid is related to the density, the gravitational constant and the height of the fluid as follows:

P=ρ·g·h

where

P=pressure in Pascals,

ρ=the density of the fluid in kg/m³

g=the gravitational constant (9.8 m/s²) and

h=height of fluid in meters, as measured from an arbitrary plane.

Use of fluid displacement device 40 does not alter the height “h” of the fluid within sump 110. Thus, if the fluid level is filled to point B in both cases, i.e., in FIG. 4 and FIG. 5, the head pressure in sump 110 with fluid displacement device 40 is no different than the head pressure in sump 110 without fluid displacement device 40.

As will be appreciated, reducing the amount of fluid F used in each cycle of washer 10 can significantly reduce the amount of fluid F used in an overall washing operation. For example, in tests conducted with a conventional washer, wherein 12.6 gallons of fluid F were required to establish an adequate pressure to prime a pump to operate at a level to produce an output of 240 gallons/minute, insertion of fluid displacement device 40 into the sump reduced the volume of fluid necessary to prime the pump (and operate the pump during washing and rinsing cycles) to 9.5 gallons. Similarly, the same washer would normally have only a single fluid level sensor and would require the same 12.6 gallons to prime a pump for a low-operating speed to produce an output of approximately 80 to 100 gallons/minute. By adding fluid displacement device 40 into the sump and by using low level sensor 92 to establish a lower fluid level sufficient to prime pump 64 for low speed operation, the required fluid to prime and operate the pump at the low-operating speed was reduced to 5.8 gallons. In this respect, a fluid saving of approximately 25% is achieved at the high operating pump speed, and a fluid saving of over 50% is achieved at the low operating pump speed. The reduction in the necessary amount of fluid required to operate washer 10 represents a savings both in water consumption, as well as in the chemicals used to create the washing fluids and rinsing fluids. The present invention thus provides a washer 10 and sump assembly 30 that significantly improves the efficiency of such washers and further reduces the likelihood of detrimental cavitation of the pumps used therein.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A washer including a plurality of spray jets disposed within a washing chamber for spraying washing and rinsing fluids into the washing chamber, conduits for supplying the washing and rinsing fluids to the jets, a sump located at the bottom of the washing chamber for collecting the washing and rinsing fluids sprayed from the jets, a pump for re-circulating the washing and rinsing fluids from the reservoir to the conduits and nozzles, the washer further comprising:
a fluid displacement device centrally disposed within said sump, said fluid displacement device dimensioned to displace fluid within said sump and to define a generally annular sump chamber surrounding said fluid displacement device that communicates with said pump.

2. A washer as defined in claim 1, wherein said sump is generally rectangular in shape.

3. A washer as defined in claim 2, wherein said fluid displacement device is generally rectangular in shape and defines a sump chamber that is rectangular in shape.

4. A washer as defined in claim 3, wherein said sump chamber is uniform in width.

5. A washer as defined in claim 4, wherein said sump includes a fluid outlet communicating with said pump, and said fluid displacement device is disposed above and spaced from said outlet.

6. A washer as defined in claim 1, further comprising a heating element disposed within said sump chamber.

7. A washer as defined in claim 6, wherein said heating element is coiled around said fluid displacement device.

8. A washer as defined in claim 1, wherein said sump without said fluid displacement device has a fixed fluid capacity and said fluid displacement device is dimensioned to displace a specific amount of said fixed fluid capacity.

9. A washer as defined in claim 6, wherein said fluid displacement device is a hollow canister.

10. A washer as defined in claim 1, further comprising two fluid level sensors in said sump.

11. A washer as defined in claim 10, wherein said washer includes a first fluid level sensor within said sump to establish a first fluid level in said sump to prime said pump for a first operating speed and a second fluid level sensor within said sump to establish a second fluid level in said sump to prime said pump for a second operating speed.

12. A washer as defined in claim 11, wherein said second operating speed is less than said first operating speed and said second fluid level is below said first fluid level.

13. A reservoir for a washer which includes a washing chamber, a plurality of spray jets disposed within the washing chamber, conduits for supplying washing and rinsing liquids to the spray jets, and a pump connected to the conduits for recirculating the washing and rinsing fluids within the washer to the spray jets, the reservoir comprising:
a cavity having a fixed fluid capacity disposed at the bottom of the washing chamber, and
a hollow body centrally disposed within said cavity to displace a fixed volume of said fluid capacity, said hollow body defining an annular reservoir cavity that communicates with said pump.

14. A reservoir for a washer as defined in claim 13, wherein said reservoir is generally rectangular in shape.

15. A reservoir for a washer as defined in claim 14, wherein said fluid displacement device is generally rectangular in shape and defines a sump chamber that is rectangular in shape.

16. A reservoir for a washer as defined in claim 15, wherein said sump chamber is uniform in width.

17. A reservoir for a washer as defined in claim 16, wherein said sump chamber includes a fluid outlet communicating with said pump, and said fluid displacement device is disposed above and spaced from said outlet.

18. A reservoir for a washer as defined in claim 13, further comprising a heating element disposed within said sump chamber.

19. A reservoir for a washer as defined in claim 18, wherein said heating element is coiled around said fluid displacement device.

20. A reservoir for a washer as defined in claim 13, wherein said fluid displacement device is a hollow canister.

21. A reservoir for a washer which includes a washing chamber, a plurality of spray jets disposed within the washing chamber, conduits for supplying washing and rinsing liquids to the spray jets, and a pump connected to the conduits for re-circulating the washing and rinsing fluids within the washer to the spray jets, the reservoir comprising:
an annular cavity disposed at the bottom of the washing chamber, said cavity being in communication with said pump and being formed around a hollow chamber, said annular cavity having a predetermined height sufficient to prime said pump and a volume sufficient to operate said pump when said annular cavity is filled with a fluid.

22. A reservoir for a washer as defined in claim 21, further comprising a coiled fluid heating element disposed in said annular cavity.

23. A washer including a plurality of spray jets disposed within a washing chamber for spraying washing and rinsing fluids into the washing chamber, conduits for supplying the washing and rinsing fluids to the jets, a sump located at the bottom of the washing chamber for collecting the washing and rinsing fluids sprayed from the jets, a pump having at least two operating speeds for re-circulating the washing and rinsing fluids from the reservoir to the conduits and nozzles, a fluid displacement device centrally disposed within said sump to displace fluid within said sump, a first fluid level sensor within said sump to establish a first fluid level in said sump to prime said pump for a first operating speed and a second fluid level sensor within said sump to prime said pump for a second operating speed.
